(19) United States
(12) Patent Application Publication
(10) Pub. No.: US 2019/0389064 A1
(43) Pub. Date: Dec. 26, 2019

(54) UNIVERSAL ROBOT AND DEVICE SUPPORT SYSTEM

(71) Applicant: Walmart Apollo, LLC, Bentonville, AR (US)

(72) Inventors: Donald R. HIGH, Noel, MO (US); John J. O'BRIEN, Farmington, AR (US); Brian MCHALE, Oldham (GB); Robert CANTRELL, Herndon, VA (US)

(73) Assignee: Walmart Apollo, LLC, Bentonville, AR (US)

(21) Appl. No.: 16/450,183

(22) Filed: Jun. 24, 2019

Related U.S. Application Data
(60) Provisional application No. 62/689,635, filed on Jun. 25, 2018.

(51) Int. Cl. B25J 9/16; B25J 13/08

(52) U.S. Cl. CPC B25J 9/1674; B25J 9/1664; B25J 9/163; B25J 13/08

(57) ABSTRACT

A support system for an autonomous robot may include a diagnostic component coupled to the autonomous robot; one or more on-board sensors coupled to the autonomous robot, the one or more on-board sensors configured to communicate with the diagnostic component; a servicing alignment engine configured to store information, the servicing alignment engine configured to communicate with the diagnostic component; and an auxiliary robot configured to communicate with the diagnostic component. The diagnostic component is configured to continuously monitor a status of the autonomous robot, determine if the status is within a predetermined operating value, and send a notification to the auxiliary robot based on the status. The auxiliary robot is configured to determine a remedial action based on a notification that the status is outside of the predetermined operating value and initiate the remedial action on the autonomous robot when the status is not within the predetermined operating value.

### CROSS REFERENCE TO RELATED APPLICATIONS

This present patent application claims priority benefit from U.S. Provisional Patent Application No. 62/689,635 filed on Jun. 25, 2018, the entire content of which is hereby incorporated herein by reference.

### TECHNICAL FIELD OF THE INVENTION

Embodiments of the present invention relate generally to a system for supporting a universal robot.

### BACKGROUND OF THE INVENTION

Robots may be used autonomously to perform tasks such as stocking warehouse and retail shelves, taking inventory of products on warehouse and retail shelves, etc. Such autonomous robots may need to be serviced or repaired to ensure proper functionality. Currently, servicing and repair of robots requires taking the robots out of service by personnel. The robot may not be discovered to need repair or servicing until long after the robot has become inactive or inoperative. This may cause delays in servicing and repair of the robot and increased downtime of the robot that may lead to increased costs associated with the use of autonomous robots. Thus, a need exists for a support system that may operate with the robot to autonomously, or semi-autonomously, monitor the robot for needed servicing or repairing and navigate the robot or alert personnel that the robot is in need of the servicing or repair.

### BRIEF SUMMARY OF THE INVENTION

According to an embodiment of the present disclosure, a support system for an autonomous robot may include a diagnostic component coupled to the autonomous robot; one or more on-board sensors coupled to the autonomous robot, the one or more on-board sensors configured to communicate with the diagnostic component; a servicing alignment engine configured to store information, the servicing alignment engine configured to communicate with the diagnostic component; and an auxiliary robot configured to communicate with the diagnostic component. The diagnostic component may be configured to continuously monitor a status of the autonomous robot, determine if the status is within a predetermined operating value, and send a notification to the auxiliary robot based on the status. The auxiliary robot may be configured to determine a remedial action based on a notification that the status is outside of the predetermined operating value and initiate the remedial action on the autonomous robot when the status is not within the predetermined operating value.

According to an embodiment of the present disclosure, a method for supporting an autonomous robot may include monitoring an on-board sensor with a diagnostic component coupled to the autonomous robot; analyzing a value sensed by the on-board sensor with the diagnostic component; determining a result of the analyzing to be outside of a predetermined operating parameter; communicating the result to an auxiliary robot; navigating the auxiliary robot to the autonomous robot; and performing a remedial action on the autonomous robot with the auxiliary robot. Performing the remedial action with the auxiliary robot may occur while the autonomous robot continues to perform an assigned task.

### BRIEF DESCRIPTION OF DRAWINGS

The accompanying drawing, which are included to provide a further understanding of the invention and are incorporated in and constitute a part of this specification, illustrate preferred embodiments of the invention and together with the detailed description serve to explain the principles of the invention. In the drawing:

FIG. 1 shows a schematic of a support system for a robot, according to an embodiment.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. A person skilled in the relevant art would recognize that other equivalent parts can be employed and other methods developed without departing from the spirit and scope of the invention. All references cited herein are incorporated by reference as if each had been individually incorporated.

The present disclosure relates to a system for monitoring an autonomous robot and communicating with a user, server, additional autonomous robot, or combinations thereof to take action based on the monitoring. For example, the system may determine when the robot is operating outside of programmed parameters, is in need of charging, is in need of a software update, needs parts repaired, replaced, or cleaned, or in need of other servicing. The system may monitor on-board technology and/or on-board sensors of the robot. The system may analyze the values of the monitoring and instruct the robot to take a predetermined action and/or alert a server, user, additional autonomous robot, or combinations thereof that action needs to be taken.

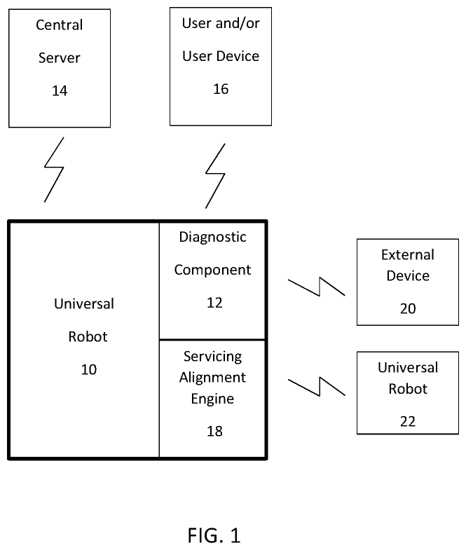

Referring to FIG. 1, a schematic of a support system for a device, such as a robot 10, is shown. The robot 10 may be a universal robot. Although described as a robot, the device may be any vehicle or device that operates autonomously and has a need for monitoring. A diagnostic device or diagnostic component 12 may be coupled or attached to the robot 10. The diagnostic component 12 may provide monitoring of the robot 10. The diagnostic component 12 may provide continuous and real time monitoring and control of the robot 10. The diagnostic component 12 may monitor and identify repair, support, and/or maintenance needs of the robot 10. For example, the diagnostic component 12 may communicate with and monitor on-board sensors or on-board technology on the robot 10. The diagnostic component 12 may ensure that the sensors and technology on the robot 10 are able to power on and off and that the sensor and technology are in the proper state (e.g. on or off) when the robot 10 initiates a request to turn the sensor and/or other technology on or off. The diagnostic component 12 may ensure that the sensors and technology are performing within predetermined operating parameters.

The diagnostic component 12 may capture and collect information or data, such as sensor values, from the robot 10. The diagnostic component 12 may communicate the information to a central server 14 to identify anomalies. For example, the diagnostic component 12 may communicate sensor values to the central server 14. The central server 14 may analyze the data collected from the robot 10. The central server 14 may compare the data (e.g. sensor values) to preset or predetermined values or ranges of values. The predetermined values or ranges of values may identify acceptable operating conditions for the robot 10. The predetermined values may be programmed into the central server 14 and/or the diagnostic component 12. The predetermined values may be unique to the robot 10 and/or the task performed by the robot 10. Accordingly, the predetermined values may be changed by a user 16, the central server 14, and/or other devices, such as a docking station, repair station, or home location.

The central server 14 or diagnostic component 12 may identify when the data (e.g. sensor values) exceeds predetermined thresholds or is outside of predetermined ranges. If the data is determined to be below (or above, or otherwise conforming with) the predetermined threshold or within (or otherwise conforming with) the predetermined range, the central server 14 may determine the robot 10 is operating within acceptable conditions or parameters. The central server 14 may communicate the results to the diagnostic component 12 and/or the user 16 identifying the robot 10 is operating within parameters. If the data (e.g. the sensor values) is determined by the central server 14 to exceed (or be below or otherwise not conform with) the predetermined threshold or to be outside (or otherwise not conform with) a predetermined range, the central server 14 may determine the robot 10 is operating outside of acceptable conditions or parameters. The central server 14 may communicate the results to the diagnostic component 12 and/or the user 16. The diagnostic component 12 may determine a remedial action and may issue a command to the robot 10 to remediate the unacceptable value. For example, the diagnostic component 12 may send the robot 10 to a home location or repair station for repair or maintenance. Alternatively or additionally, the central server 14 may determine the remedial action and issue the action to the diagnostic component 12 and/or the robot 10. Alternatively or additionally, the central server 14 may send an auxiliary or additional robot or robots to the robot 10 to perform the repair, maintenance, debugging, remedial action, or other action as determined by the central server 14.

Alternatively or additionally, the diagnostic component 12 may analyze the data collected from the robot 10. The diagnostic component 12 may compare the sensor values to preset or predetermined values or ranges of values. The diagnostic component 12 may identify when the sensor values are conforming with acceptable values and thresholds, thus identifying when the robot 10 is operating within acceptable parameters. The diagnostic component 12 may communicate the results to the central server 14 and/or the user 16. The diagnostic component 12 may determine a remedial (or other) action based on the analyzed values. The diagnostic component 12 may issue a command to the robot 10. The diagnostic component 12 may communicate with the central server 14 and/or the user 16 to notify the central server 14 and/or user 16 of the status and location of the robot 10.

The diagnostic component 12 may communicate messages and/or alerts to a user device or user 16, the central server 14, an auxiliary or additional autonomous robot(s), or combinations thereof. The user device may be an internet connected device, such as a tablet, phone, speaker, computer, or other user operated device. The diagnostic component 12 may communicate with the user 16 (or other devices/systems as previously mentioned) using natural language processing to report the conditions of the robot 10. The diagnostic component 12 may include an audio speaker, visual alert, or other alert messaging that may indicate to the user 16 and/or the central server 14 the status of the robot 10. The diagnostic component 12 may communicate in any of the aforementioned manners with other external devices 20, such as internet connected devices, such as a charging station, a docking station, repair station, home location, etc., auxiliary or additional autonomous robots, servers, the central server 14, and combinations thereof.

As previously mentioned, the diagnostic component 12 may monitor the robot 10 and determine if the robot 10 is operating within predetermined parameters. If the diagnostic component 12 determines the robot 10 is not operating within predetermined, normal operating parameters, the diagnostic component 12 may initiate a remedial action. The remedial action may be a diagnostic program to determine the exact nature of the problem or anomaly. The diagnostic program may include rebooting the power of the robot 10, rebooting the software of the robot 10, formatting, updating, or debugging the software of the robot 10, or combinations thereof. The diagnostic component 12 may be communicating with the central server 14 and/or user 16 during the process and may alert the central server 14 and/or user 16 of the success or failure of such remedial action. If the remedial action does not correct the anomaly, the diagnostic component 12 may initiate a subsequent or follow-up action. Alternatively, the central server 14 and/or user 16 may issue instructions to the diagnostic component 12 for further action or issue instructions for returning the robot 10 to a home location or repair station. Although described is communicating with the central server 14 and/or user 16, the robot 10 may communicate with any number of systems or devices, such as those described herein, and not limited to, for example, an auxiliary or additional robot.

The robot 10 and/or diagnostic component 12 may include a kill-switch, safety-switch, or emergency stop feature. The kill switch may be a safety mechanism used to shut off the robot 10 in an emergency or in a situation where the robot 10 is unable to shut down in the usual or normal manner. During monitoring, the diagnostic component 12 may determine that the robot 10 is inoperable. The diagnostic component 12 may be unable to communicate with the robot 10, monitor the sensors or technology aboard the robot 10, instruct the robot 10, and/or may be unable to shut off the robot 10 in the normal course. The diagnostic component 12 may initiate the kill-switch to deactivate the robot 10 and/or prevent the robot 10 from being turned on. This may operate as a safety feature to prevent or limit damage of the robot 10, injury to persons, or damage to external devices or items. The diagnostic component 12 may communicate to the central server 14 and/or the user 16 that the robot 10 is inoperable. The diagnostic component 12 may communicate to the central server 14 and/or the user 16 the location of the robot 10 for retrieval. The robot 10 may be maintained in the deactivated position until maintenance and/or repair is performed. Alternatively, or additionally, the user 16, central server 14, auxiliary or additional robot, or combinations thereof, may be able to actuate the kill-switch to deactivate the robot 10 based on data received from the diagnostic component 12.

The diagnostic component 12 may monitor a position or location of the robot 10. The diagnostic component 12 may be used as a localization system or method to communicate the position of the robot 10 to the user 16 and/or the central server 14. The robot 10 and/or the diagnostic component 12 may include one or more position sensors. The one or more position sensors may sense a relative position, such as XYZ coordinates of the robot 10. Alternatively, the robot 10 may emit a beacon associated with the location or position of the robot 10. The diagnostic component 12, central server 14, user 16, auxiliary or additional robot, or combinations thereof, may detect the beacon and triangulate the position of the robot 10. Alternatively, the diagnostic component 12 may emit a beacon associated with the location or positon of the robot 10. The central server 14 user 16, auxiliary or additional robot, or combinations thereof, may detect the beacon and triangulate the position of the diagnostic component 12 and thus the robot 10. Alternatively, the central server 14, user 16, auxiliary or additional robot, or combinations thereof, may receive from a positioning service, such as Wi-Fi, the location or position of the diagnostic component 12 and/or robot 10. The work area of the robot 10 may be mapped such that the diagnostic component 12 may sense a position of the robot 10 within the mapped area. The diagnostic component 12 may communicate the position of the robot 10 to the central server 14, user 16, auxiliary or additional robot, or combinations thereof.

The diagnostic component 12 may communicate with the robot 10, central server 14, user 16, or other devices (e.g., additional robots or repair/maintenance stations) through wired connections/communication, wireless connections/communication, short-range radio waves (e.g. Bluetooth), or other communication types. The diagnostic component 12, robot 10, central server 14, user 16, or other devices may be equipped with two-way communication such that each of the devices described herein may transmit signals and may receive signals. The diagnostic component 12, robot 10, central server 14, user 16, additional robot(s), stations, and/or other devices may transmit and/or receive signals associated with sensor data, information, alerts, and/or instructions.

The previously described on-board sensors and on-board technology may include one or more of the following: position sensor(s), optical sensor(s), camera(s), thermal sensor(s), multispectral camera(s), geopositional sensor(s), global position system(s), infrared sensor(s), electro-optical sensor(s), etc. The on-board technology may also include tools or devices for performing functions. For example, the on-board technology may include hands, grippers, and/or cameras for performing tasks such as stocking and restocking retail or warehouse shelves, moving product, performing inventory of product, etc. The on-board technology may include wheels, continuous tracks, or other movement types. The on-board technology may include fans, hardware, engines, motors, or other devices for operation of the robot 10.

In an exemplary embodiment, a robot 10 may be operating autonomously in a remote location performing an assigned task, such as, for example, stocking shelves or taking inventory in a warehouse or retail store. The diagnostic component 12 may be continuously monitoring the sensors on the robot 10 to ensure the robot 10 is operating within parameters. The diagnostic component 12 may determine, for example, that the robot 10 is in need of battery charging. The diagnostic component 12 may instruct the robot 10 to navigate to a charging station autonomously. The diagnostic component 12 may communicate with the user 16 to alert the user 16 that the robot 10 is navigating from the remote location to the charging station. The robot 10 may be charged and return to the remote location autonomously to continue the previously assigned task. In an example, the diagnostic component 12 may communicate to a user 16 and/or the central server 14 that the robot 10 is in need of charging. The diagnostic component 12 may also communicate the location (e.g. with GPS) to the user 16 and/or central server 14. The user 16 or other personnel or equipment may retrieve the robot 10 from the remote locate and return the robot 10 to a charging station. In an example, the diagnostic component 12 may communicate to an auxiliary or additional robot that the robot 10 is in need of charging. The additional robot may navigate to the robot 10 and recharge the robot 10 while the robot 10 continues to perform the assigned task.

In an exemplary embodiment, a robot 10 may be operating autonomously in a remote location performing an assigned task, such as previously described. The diagnostic component 12 may be continuously monitoring the sensors on the robot 10 to ensure the robot 10 is operating within parameters. The diagnostic component 12 may also be communicating with another device, such as a docking station. The docking station may communicate to the diagnostic component 12 that an update is needed for the robot 10. Alternatively, the diagnostic component 12 may determine that the robot 10 is operating outside of parameters and in need of updating, rebooting, or debugging. The diagnostic component 12 may instruct the robot 10 to navigate to the docking station autonomously. The diagnostic component 12 may communicate with the user 16 to alert the user 16 that the robot 10 is navigating from the remote location to the docking station. The robot 10 may be updated and return to the remote location autonomously to continue the previously assigned task. In an example, the diagnostic component 12 may communicate to a user 16 that the robot 10 is in need of updating. The diagnostic component 12 may also communicate the location (e.g. with GPS) to the user 16. The user 16 may retrieve the robot 10 from the remote locate and return the robot 10 to the docking station. The user 16 may also, or alternatively, update the robot 10 at the robot's current location, in some examples, while the robot 10 continues to perform the assigned task. In an example, the diagnostic component 12 may perform the updating, rebooting, or debugging on the robot 10. In an example, the diagnostic component 12 may communicate to an auxiliary or additional robot that the robot 10 is in need of updating. The additional robot may navigate to the robot 10 and update the robot 10 while the robot 10 continues to perform the assigned task.

The robot 10 may include a servicing alignment engine 18. The servicing alignment engine 18 may identify qualified solutions for servicing the robot 10. For example, the servicing alignment engine 18 may store a database of auxiliary robots, technicians and the technicians' capabilities, tools, experience, certification, etc. The servicing alignment engine 18 may thus identify a technician or auxiliary robot with the required capabilities, tools, experience, or certification, etc. to perform the maintenance or repair of the robot 10 determined by the diagnostic component 12. The diagnostic component 12 may communicate to the identified technician or auxiliary robot that the robot 10 is in need of a particular repair or maintenance and communicate the location of the robot 10 and/or navigate the robot 10 to the technician or auxiliary robot for servicing.

The servicing alignment engine 18 may also store locations for identifying local technicians or auxiliary robots aligned with a location the request originates from. For example, the servicing alignment engine 18 may store or monitor locations of technicians or auxiliary robots. The servicing alignment engine 18 may also store the capabilities, tools, etc. of each technician or auxiliary robot, as described above. When the diagnostic component 12 determines action is needed for the robot 10, the diagnostic component 12 may query the servicing alignment engine 18 to determine the closest technician or auxiliary robot with the required capabilities and/or tools. The diagnostic component 12 may send an alert to the identified technician or auxiliary robot indicating the problem, anomaly, or servicing required and the location of the robot 10. The technician or auxiliary robot may report to the robot 10 for servicing of the robot 10. Alternatively, the diagnostic component 12 may alert the identified technician or auxiliary robot, as previously noted, and navigate the robot 10 to the technician or auxiliary robot for servicing, repair, or maintenance. The servicing alignment engine 18 may communicate autonomously a need for servicing of a robot 10 with another servicing alignment engine 18 (e.g., a servicing alignment engine on an auxiliary robot). The servicing alignment engine 18 may also be separate from the robot 10.

Any of the systems described herein may comprise a servicing library. The servicing library may be included with the diagnostic component 12, servicing alignment engine 18, central server 14, user 16, station, auxiliary robot, or combinations thereof. The servicing library may store a database or catalog of types and number of devices, machines, or robots in a larger system, such as a warehouse or retail space. Each device or robot may include a unique identifier to identify the device within the servicing library. The servicing library may store a database or catalog of issues that may arise during operation of the devices (e.g. robots), for example, communication status, transmission status, battery status, updates, navigation, on-board sensors, on-board technology, etc. The servicing library may store a database or catalog of issue details, such as permissible values or thresholds of the monitored on-board sensor(s) or technology. The servicing library may store a maintenance log or record of maintenance, servicing, or updates performed on the robot. The servicing alignment engine 18 may be consulted by the diagnostic component 12 or central server 14 to identify issue and potential solutions.

The system described herein may allow for machine-machine repair or service (e.g. robot to robot repair or service). For example, the diagnostic component 12 of the robot 10 may communicate with a diagnostic component of a second or auxiliary robot 22. The robot 10 and/or diagnostic component 12 of the robot 10 may request for the auxiliary robot 22 and/or diagnostic component of the auxiliary robot 22 to troubleshoot, update, repair, service, end troubleshooting, etc. Thus, the auxiliary robot 22 may be able to service the robot 10. The auxiliary robot 22 may be able to identify when machine-machine service is not correcting the anomaly. The auxiliary robot 22 may end troubleshooting of the robot 10 and alert the server 14 and/or user 16 or alert a technician and/or return the robot 10 to a home location or other station. The auxiliary robot 22 may be another task robot, such as the robot 10, such that any robot 10 of the fleet of robots may be capable of repairing any other robot 10 within the fleet. The auxiliary robot 22 may be a dedicated servicing robot, such that the auxiliary robot 22 is able to service any of the robots 10 when servicing is needed. The auxiliary robot 22 may be one robot in a fleet of autonomous, dedicated servicing robots. In this manner, the fleet of servicing robots 22 may be available to autonomously maintain and/or repair the fleet of task robots 10 without (or with little) human interaction.

In an exemplary embodiment, the robot 10 may be performing a task. The robot 10 may identify (e.g., via the diagnostic component 12) a servicing need (e.g., repair, charge, etc.). The robot 10 may send a request to the central server 14, user 16, and/or the auxiliary robot 22 identifying the particular action needed. The auxiliary robot 22 may receive the request (e.g., directly from the robot 10 and/or from the user 16 or central server 14). The auxiliary robot 22 may navigate to the robot 10. The auxiliary robot 22 may service the robot 10. The robot 10 may continue to perform the assigned task while the auxiliary robot 22 performs the servicing and/or repair. The robot 10 may halt the assigned task while the auxiliary robot 22 performs the servicing and/or repair. Once completed, the auxiliary robot 22 may navigate to a home location and/or to another robot 10 in need of servicing.

The auxiliary robot 22 may be equipped with tools, equipment, parts, or software to service the robot 10. In an embodiment, there may be a fleet of auxiliary robots 22 where each auxiliary robot 22 is equipped to perform a particular action or service (e.g., a recharging robot, a debugging robot, an equipment repair robot, etc.) or a subset of actions or services. The auxiliary robot 22 may be permanently equipped to deal with a particular task such that no human intervention is needed. Alternatively, or additionally, a human may equip the auxiliary robot 22 with a particular tool or software to address the instant need of the robot 10. The auxiliary robot 22 may be restocked (autonomously or by a user) before, after, or during servicing of a robot 10.

Thus, the robot 10 may navigate to a service location, personnel, or robot and/or the service location, personnel or robot may navigate to the robot 10. As discussed, the system (e.g., any of the robot 10, server 14, user 16, servicing unit 18, external device 20, robot 22, or combinations thereof) may monitor thresholds of performance, that is, the system may predict that a robot 10 will stop functioning and that the reason could be, for example, the level of charge (e.g., a draining battery) or other technical issue. At this time, the auxiliary robot 22 and/or the robot 10 may navigate to the appropriate location to remedy the issue (e.g., charging the battery of the robot 10).

Thus, the system benefits from the continued (or minimally interrupted) operation of the robot 10 and/or the fleet of robots 10. In an example, the auxiliary robot 22 acts as a recharger or battery swapper that may attach to a robot 10 performing a task while the robot 10 continues to work/perform the task. The auxiliary robot 10 may provide power to the robot 10 while recharging or swapping the battery of the robot 10. In an example, the auxiliary robot 22 may be another robot 10 performing a task. The auxiliary robot 22 may have a mirror component to a component that is failing inside the robot 10. While servicing the robot 10 (e.g., while attached or connected, either physically or virtually, to the still working robot 10) the mirror component on the auxiliary robot 22 takes over and performs the task the robot 10 is performing. In an embodiment, the mirror component may be located on a remote server (e.g., central server 14) and may take over in a similar manner to perform the assigned task of robot 10. The auxiliary robot 22 fixes or replaces the failing part on the robot 10 while the mirror component handles the robot's 10 tasks. Thus avoiding expensive downtime so the robot 10 (and fleet of robots 10) may be kept working 24/7.

As discussed, the connection between the auxiliary robot 22 and the robot 10 may be physical and/or virtual. That is, the auxiliary robot 22 may mechanically or physically couple to the robot 10 to perform the servicing task. The auxiliary robot 22 may virtually (e.g., communicatively) couple to the robot 10. The virtual coupling may be communication of respective diagnostic components 12. The virtual coupling may be by way of the central server 14. The auxiliary robot 22 may either, collectively or individually, mechanically/physically couple or virtually couple to the robot 10 depending on the required servicing task.

The foregoing system may allow for the universal robot 10 to operate autonomously without intervention from a user. The foregoing system may thus reduce downtime and costs associated with repair since the robot 10 may autonomously initiate repair, servicing, updating, or maintenance of the components of the robot 10. The foregoing system may allow for a servicing request (e.g. repair, maintenance, servicing, etc.) to originate from the machine (e.g. robot 10), the diagnostic component 12, a user 16 (e.g. a retail or warehouse associate or technician, etc.), a central server 14, and/or another robot 22. The foregoing system may allow for the servicing request to originate from any location, for example a location of the robot 10 within a warehouse or retail space, etc.

In exemplary embodiments, the service request may originate from the device itself, a machine that communicates with the device and identifies an issue (the communication is in error, nit compliant with formats, or include values out of range, a store associate, etc. The service request may be received by the system and processed. The servicing library may be used to process the service request, identify potential issue and solutions. This may be done by identifying the device type, comparing operating parameters of the device with parameters from the library, and correlating the same with identified issues. In some cases this may be done in connection with the diagnostic component and service alignment engine. The foregoing system may allow for the service request to originate when any number of issues arises, for example, values or variables outside of predetermined operating parameters.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Although the embodiments of disclosure have been described in detail for the purpose of illustration based on what is currently considered to be the most practical, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

We claim:

1. A support system for an autonomous robot, the support system comprising:
a diagnostic component coupled to the autonomous robot;
one or more on-board sensors coupled to the autonomous robot, the one or more on-board sensors configured to communicate with the diagnostic component;
a servicing alignment engine configured to store information, the servicing alignment engine configured to communicate with the diagnostic component; and
an auxiliary robot configured to communicate with the diagnostic component,
wherein the diagnostic component is configured to continuously monitor a status of the autonomous robot, determine if the status is within a predetermined operating value, and send a notification to the auxiliary robot based on the status, and
wherein the auxiliary robot is configured to determine a remedial action based on a notification that the status is outside of the predetermined operating value and initiate the remedial action on the autonomous robot when the status is not within the predetermined operating value.

2. The support system of claim 1, wherein the servicing alignment engine is configured to store information related to at least one of proximity, capability, experience, and available tools of a plurality of auxiliary robots and select the auxiliary robot based on the remedial action to be performed on the autonomous robot.

3. The support system of claim 1, wherein the support system is configured to repair the autonomous robot autonomously, contact the auxiliary robot autonomously to initiate the remedial action, and navigate the auxiliary robot autonomously to the autonomous robot for the remedial action.

4. The support system of claim 1, the diagnostic component further comprising at least one of a communication device, an audio speaker, a visual alert, a messaging system.

5. The support system of claim 1, wherein the diagnostic component is configured to communicate with external, internet connected devices.

6. The support system of claim 1, wherein the remedial action is one or more of power rebooting, software rebooting, formatting, updating, debugging, battery charging, or repairing equipment.

7. The support system of claim 1, further comprising a kill switch.

8. The support system of claim 1, further comprising a position monitoring device.

9. The support system of claim 1, wherein the diagnostic component continuously monitors the autonomous robot while the autonomous robot performs an assigned task.

10. The support system of claim 9, wherein the auxiliary robot is configured to perform the remedial action while the autonomous robot continues to perform the assigned task.

11. A method for supporting an autonomous robot, the method comprising:
monitoring an on-board sensor with a diagnostic component coupled to the autonomous robot;
analyzing a value sensed by the on-board sensor with the diagnostic component;
determining a result of the analyzing to be outside of a predetermined operating parameter;
communicating the result to an auxiliary robot;
navigating the auxiliary robot to the autonomous robot; and
performing a remedial action on the autonomous robot with the auxiliary robot,
wherein performing the remedial action with the auxiliary robot occurs while the autonomous robot continues to perform an assigned task.

12. The method of claim 11, further comprising sending instructions for the remedial action of the autonomous robot to one of a plurality of auxiliary robots based on one or more of proximity, capability, experience, or available tools of each of the plurality of auxiliary robots.

13. The method of claim 11, wherein the analyzing further comprises comparing the value to a predetermined threshold.

14. The method of claim 11, wherein the remedial action is one or more of a service, repair, maintenance, software update, or battery charge.

15. The method of claim 11, further comprising a servicing alignment engine storing information related to one or more of proximity, capability, experience, or available tools of a plurality of auxiliary robots.

16. The method of claim 11, wherein the method is performed autonomously with no human intervention.

17. The method of claim 11, further comprising alerting a user or central server of an anomaly of the autonomous robot.

18. The method of claim 11, wherein the autonomous robot is a task robot configured to perform the assigned task, and wherein the autonomous robot is one robot in a fleet of autonomous robots.

19. The method of claim 18, wherein the auxiliary robot is another task robot configured to perform another assigned task and/or the same assigned task as the autonomous robot.

20. The method of claim 18, wherein the auxiliary robot is a service robot configured to repair one or more of the autonomous robots in the fleet of autonomous robots, and wherein the auxiliary robot is one robot in a fleet of auxiliary robots.
